(19) United States
(12) Patent Application Publication
(10) Pub. No.: US 2016/0005500 A1
(43) Pub. Date: Jan. 7, 2016

(54) Rack For Storage of Multiple Spent Fuel Assemblies

(71) Applicant: Curtiss-Wright Flow Control Corporation, Falls Church, VA (US)

(72) Inventor: Matthew Lee Eyre, Ulster Park, NY (US)

(21) Appl. No.: 14/322,179

(22) Filed: Jul. 2, 2014

(51) Int. Cl. G21C 19/07; G21C 19/40

(52) U.S. Cl. CPC G21C 19/07; G21C 19/40

(57) ABSTRACT

A skeleton rack for storing nuclear fuel rods, the rack having a rectangular array of vertically extending cells, the cells being formed by a plurality of elongated, relatively narrow rigid metal shafts, each disposed at a corner of a cell, rigid metal bridge members fixed to adjacent shafts proximal to upper ends of the shafts, apertured rigid metal end walls proximal to lower ends of the shafts and fixed to four shafts at corners of a respective cell.

### BACKGROUND OF THE INVENTION

The invention relates to improvements in storage racks for nuclear fuel rod assemblies.

### PRIOR ART

Spent nuclear fuel rod bundles or assemblies are commonly stored in vertically oriented racks submerged in a pool of water. The racks typically have vertically extending walls that form an array of square columnar cells. Sheets of neutron absorbing material are attached to the cell walls. A spent fuel rod bundle is lowered into a cell for storage for some period and is ultimately retrieved by raising it from the cell. Water is allowed to circulate by convection upwardly through a cell to carry heat from the fuel rod bundle.

U.S. Pat. No. 6,741,669 discloses a novel neutron absorber in the form of a two plane sheet of chevron cross-section. The neutron absorber is configured to be held in a storage rack cell by an interference fit with the cell walls.

### SUMMARY OF THE INVENTION

The invention provides a spent nuclear fuel storage rack having a skeleton frame forming an array of square, vertically extending cells. Each cell is arranged to receive a closely fitting neutron absorber sheet of chevron cross-section. The neutron absorbers are arranged in the cells in a regular pattern that allows the two planes of an absorber to block four cell faces.

In the disclosed embodiment, the framing shafts of the rack are of three cross-sectional shapes. The shapes at the periphery of the rack are angles at the corners, and tees at the sides; the shafts of the rack interior are of cruciform or cross shape. Adjacent shafts are fixed together at their ends with elements that allow vertical flow of coolant water through each cell. At their upper ends, adjacent shafts are rigidly joined by bridge plates at the periphery of associated cells. At their lower ends, adjacent shafts are joined by an apertured end wall extending across an associated cell.

The shafts, bridge plates and end walls are preferably joined with mechanical fasteners to allow a rack to be reliably and efficiently constructed with limited skill and equipment. This feature makes the rack especially suited for on-site erection.

### BRIEF DESCRIPTION OF THE DRAWINGS

FIG. 1 is a simplified perspective view of a skeleton frame fuel storage rack embodying the invention;

FIG. 2 is a fragmentary partially exploded view of an upper portion of the rack of FIG. 1;

FIG. 3 is a fragmentary perspective view of a bottom of the rack of FIG. 1;

FIG. 4 is a fragmentary cross-sectional view in a vertical plane of a bottom portion of the rack of FIG. 1;

FIG. 5 is a perspective view of a typical bottom end wall of a cell of the rack of FIG. 1;

FIG. 6 is a perspective view of a typical leg assembly of the rack of FIG. 1;

FIG. 7 is a somewhat schematic horizontal cross-sectional view of a corner portion of the rack and associated neutron absorber sheets;

FIG. 8 is a perspective view of a typical neutron absorber sheet; and

FIG. 9 is a fragmentary cross-sectional view of the upper end of an absorber sheet taken in the plane 9-9 indicated in FIG. 8.

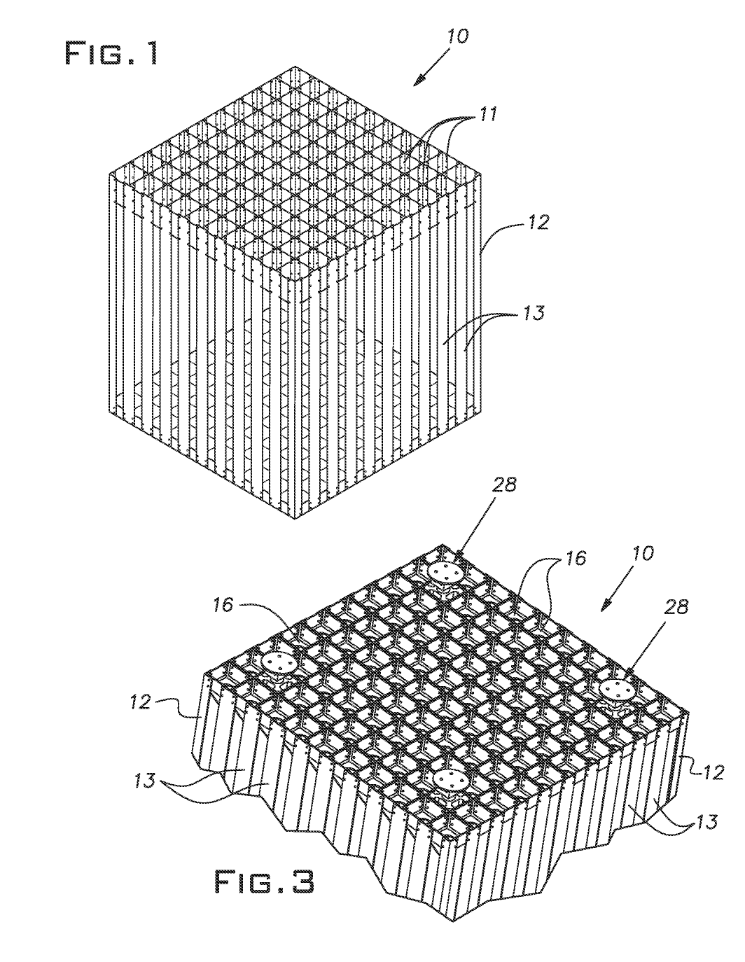

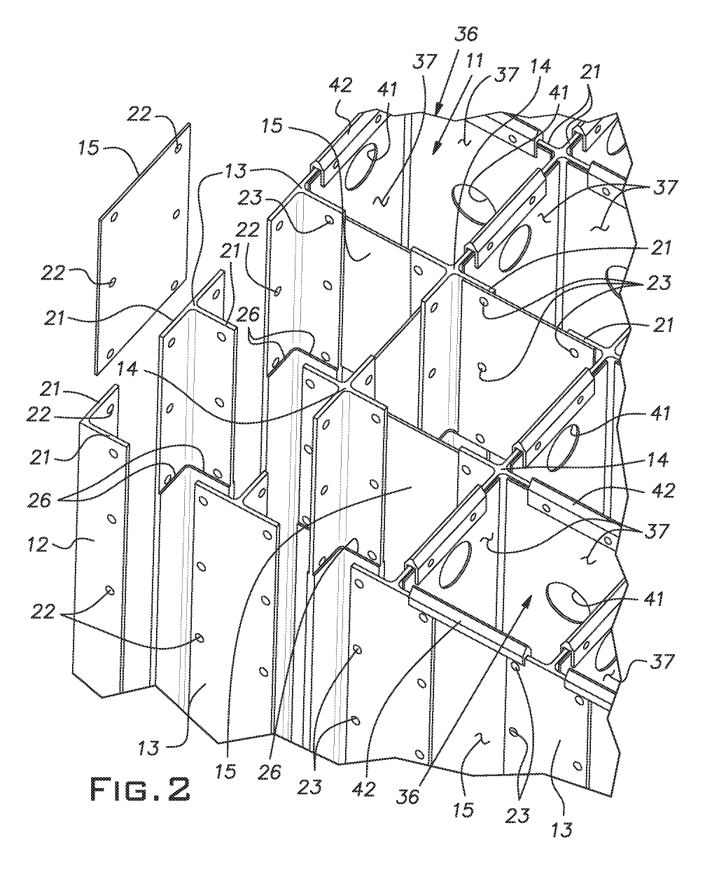

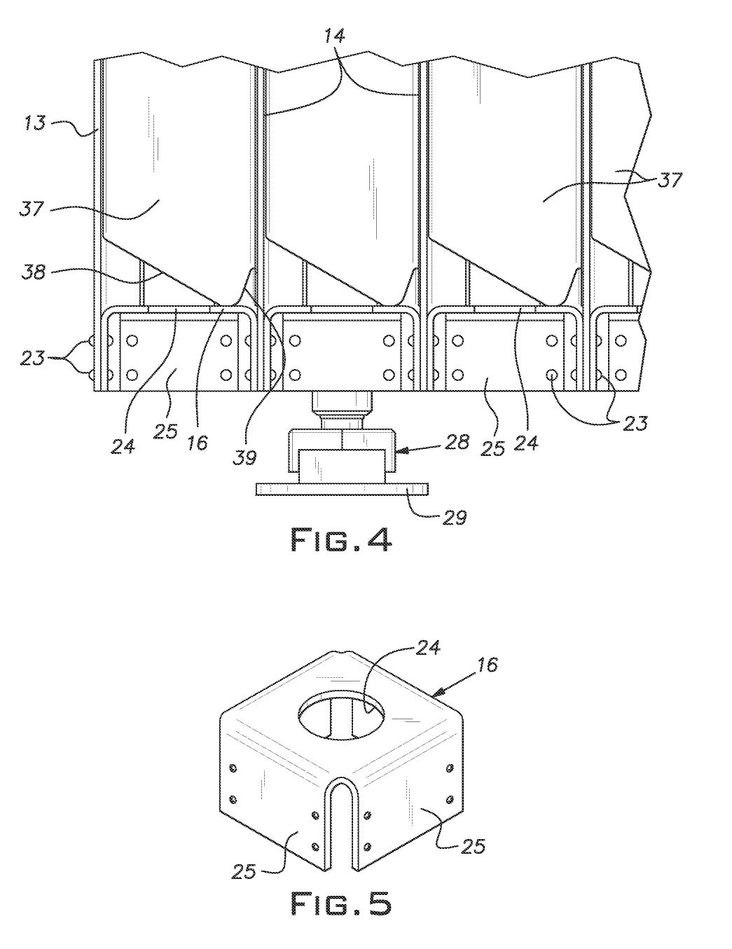

### DETAILED DESCRIPTION OF THE PREFERRED EMBODIMENT

FIG. 1 illustrates an example of a skeleton frame rack 10 for spent nuclear fuel rods. The rack 10 is ordinarily submerged in a pool of water used to cool the spent nuclear fuel. The rack 10 has an array of vertical cells 11 that individually receive and store a bundle of fuel rods sometimes referred to as a fuel assembly (not shown). By way of example, but not limitation, the cell array may be a 10 by 10 matrix, each cell can be, for example, nominally 9 or 10 inches square, and 9½ feet in length.

The rack 10 is primarily constructed of vertical shafts 12, 13 and 14, bridge plates 15, and lower end walls 16 (FIG. 5). Typically, these parts 12-16 are all aluminum or all stainless steel to minimize electrolytic corrosion. With reference to FIG. 2, for example, the shafts 12 at the corners of the rack 10 are right angles in cross-section. At the side of the rack 10, the shafts 13 are T-shaped in cross-section and at the interior of the rack, the shafts 14 have a cruciform or cross cross-section. By way of example, legs 21 of the shafts 12-14 an be between 4 inches and 6 inches in width and between ¼ inch to ⅜ inch in thickness. Preferably each shaft 12-14 is a monolithic element. In general, the shafts 12-14 are of equal length and are joined at their upper and lower ends by the bridge plates 15 and end walls 16, respectively. Preferably, the shaft, plate and end wall elements 12-16 are all pre-drilled or pre-punched with holes 22 that align with one another for reception of mechanical fasteners 23. The fasteners 23, for example, can be rivets, bolts and nuts, and/or self-drilling and/or self-tapping screws or any combination of some or all of the same.

The rack 10 can be erected at a factory, job shop, or at a site of use. The rack 10 is assembled using the selected form of fasteners, typically by technicians, starting at one side, one row of cells 11 at a time. If desired or necessary, additional bridge plates (not shown) can be provided at mid-length of the shafts 12-14.

Referring to FIG. 5, the end walls 16 are fabricated of a selected metal sheet stock. An end wall 16 has a large circular central aperture 24 and integral or monolithic depending flanges 25. The aperture 24 assures that water can freely circulate through the end wall 16 and respective cell 11 by convection. The bridge plates 15, residing in vertical planes, also assure free circulation of water upwardly through the cells 11. Upper ends of the shafts 12-14 are milled or otherwise machined with shallow pockets 26 to receive the thickness of a bridge plate 15 and to enable the plates to be quickly registered with the shafts.

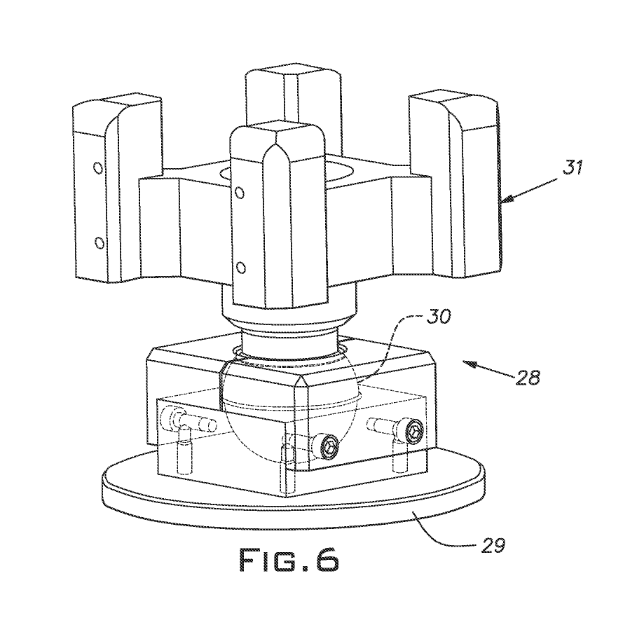

The rack 10 sits on the floor of the pool with a plurality of legs 28 provided on a lower face of the rack represented by the end walls 16. With reference to FIG. 6, each leg 28 is an assembly of a lower foot 29 providing a socket for a ball 30 depending from an upper spider-like portion 31 of the leg. Ideally, the legs 28 are formed of the same metal as the elements 12-16. In the illustrated arrangement, each leg 28 is substituted for an end wall 16 at selected locations in the lower face of the rack 10.

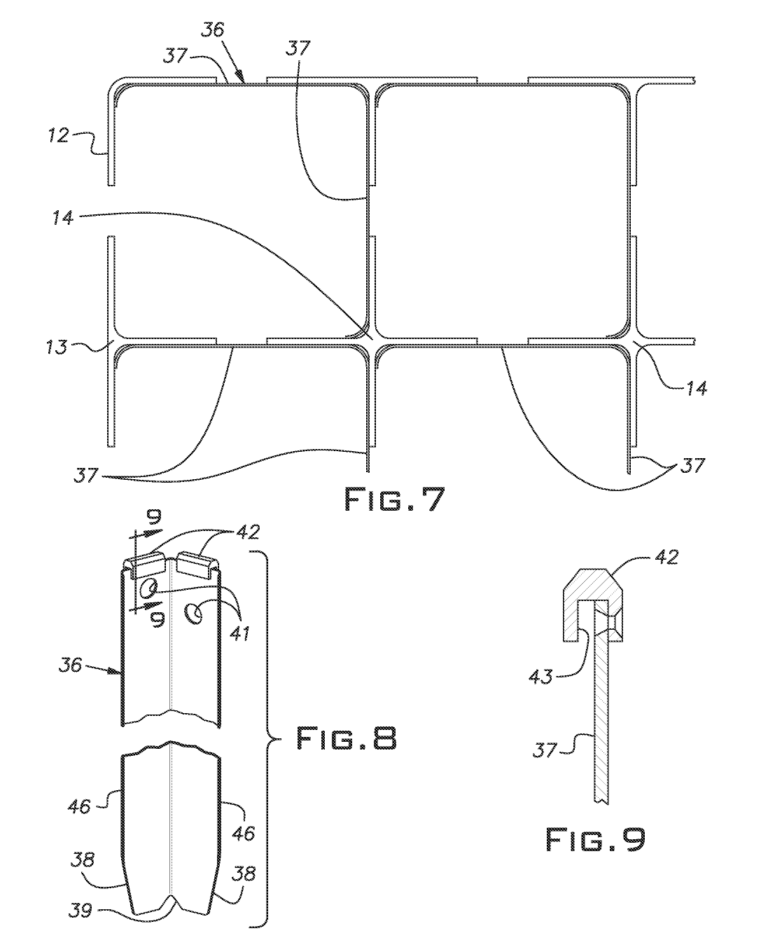

After the rack 10 is assembled, neutron absorber sheets 36, illustrated in FIG. 8, are lowered into respective cells 11. This can be accomplished, for example, with the general method and type of apparatus disclosed in aforementioned U.S. Pat. No. 6,741,669. The absorber sheets 36 can be, for example, an aluminum boron composite or a stainless steel boron alloy with a wall thickness of, for example, 0.070 inch. The sheets 36 have a length generally equal to the height of the rack 10 above the end walls 16. These and other suitable neutron-absorbing materials are disclosed in the just-cited U.S. Pat. No. 6,741,669. The neutron absorber sheet 36 has a pair of panels 37 that lie in planes that preferably diverge from one another at an angle exceeding 90 degrees, for example, 93 to 95 degrees. A lower end of each panel 37 is tapered at locations 38, 39 to facilitate insertion of these lower ends into a respective cell 11. Upper ends of the neutron absorber sheet panels 37 have holes 41 for gripping by a robotic device (not shown) that inserts a neutron absorber sheet 36 into a cell 11 or retrieves the same from a cell. As shown in FIG. 9, fixed to upper edges of the neutron absorber sheet panels 37 are guide bars 42, typically made of the material used for the main parts of the rack 10. The guide bars have the cross-section of an inverted U so as to provide a slot 43 into which is received the upper edge of a panel 37. The groove 43 is wide enough to receive the thickness of a panel 37, the thickness of a bridge plate 15 and the local thickness of the end of a shaft 12-14. The guide bars 42 are fixed to respective neutron absorber sheet panels 37 with suitable fasteners. It will be understood from the discussion below, that two outside faces of the rack 10 may not have an associated neutron absorber sheet panel associated therewith. In such cases, a guide bar 42 may be attached to the upper ends of adjacent perimeter shafts 12, 13.

As shown in FIG. 7, a neutron absorber sheet 36 is proportioned so that when the distal vertical edges of the panels 37 are elastically drawn towards one another by the installation device and/or by forces developed by the shafts 12-14 when the neutron absorber sheet 36 is lowered into a cell 11, an elastic friction fit is developed between the absorber sheet and abutting surfaces of the shafts 12-14. The guide bars 42 are beveled at their upper surfaces to assist in guiding fuel assemblies into associated cells 11. Additionally, the guide bars serve to protect the upper edges of the neutron absorber sheet panels 37 when fuel assemblies are being manipulated into or from a cell.

Consideration of FIG. 7 will reveal that two side faces of a rack 10 will be devoid of a neutron absorber sheet panel 37. Where a plurality of racks 10 exist, adjacent ones of the racks can be used to provide the absorber function from an adjacent rack. It will be seen from FIG. 7, that each cell, apart from two lines of peripheral cells, has an associated neutron absorber sheet blocking two faces of a cell and has its remaining two faces blocked by the neutron absorber sheet panels of the respective adjacent cells.

The disclosed rack construction reduces manufacturing costs by reducing material content and inventory requirements. The same shafts can be used to produce any common cell size. The construction can be provided as a kit for on-site erection thereby greatly reducing shipping costs. Assembly with mechanical fasteners reduces labor costs and the level of required skill.

It should be evident that this disclosure is by way of example and that various changes may be made by adding, modifying or eliminating details without departing from the fair scope of the teaching contained in this disclosure. The invention is therefore not limited to particular details of this disclosure except to the extent that the following claims are necessarily so limited.

What is claimed is:

1. A skeleton rack for storing nuclear fuel rods, the rack having a rectangular array of vertically extending cells, the cells being formed by a plurality of elongated, relatively narrow rigid metal shafts, each disposed at a corner of a cell, rigid metal bridge members fixed to adjacent shafts proximal to upper ends of the shafts, apertured rigid metal end walls proximal to lower ends of the shafts and fixed to four shafts at corners of a respective cell.

2. A storage rack as set forth in claim 1, wherein said bridge members and end walls are fixed to respective shafts with mechanical fasteners.

3. A skeleton rack as set forth in claim 1, wherein the shafts at the corners of the rack have an el cross-section, the shafts at a perimeter of the rack apart from the corners having a tee cross-section, and the shafts in the interior of the rack having a cruciform cross-section.

4. A skeleton rack as set forth in claim 1, wherein the shafts, bridge members and end walls have predrilled holes that receive mechanical fasteners for fixing said shafts, bridge members and end walls together.

5. A skeleton rack as set forth in claim 1, wherein said rack contains neutron absorber sheets in the cells, the neutron absorbing sheets having a chevron cross-section proportioned to be elastically compressed between a pair of diagonally opposed shafts at the corners of the respective cell.

6. A skeleton rack as set forth in claim 5, wherein said neutron absorber sheets have inverted U-shaped rigid metal guide bars attached to their upper edges for protecting said upper edges and for guiding a bundle of fuel rods into an associated cell.

7. A skeleton rack as set forth in claim 5, wherein said neutron absorber sheets are disposed in respective cells with a common orientation whereby a neutron absorber in an interior cell of the array serves to block four cell sides.

8. A skeleton rack as set forth in claim 1, wherein the bridge members are in the form of rectangular sheets and the shafts have shallow pockets adjacent their upper ends to receive said sheets.

9. A skeleton storage rack comprising a rectangular array of square columnar cells, a plurality of vertically oriented elongated rigid metal shafts located at the corners of the cells, the cells in an interior of the array having four faces, each face being in common with an adjacent cell, transverse dimension of legs of the shafts being less than half the width of a cell, rigid metal bridge elements extending between and fixed to upper ends of the shafts, apertured end walls adjacent and fixed to lower ends of the shafts, metal neutron absorber sheets of chevron cross-section in a free state formed by divergent panels, the neutron absorber sheets being disposed in a plurality of said cells, the absorber sheets being proportioned to be elastically confined in a respective cell with a cross-section that has a smaller included angle between said absorber panels than the angle between said absorber panels when the absorber panels are unconfined, the absorber sheets being located in the respective cells with the same orientation when viewed in a horizontal plane whereby each of said absorber sheets blocks four cell faces.

10. A skeleton storage rack as set forth in claim 9, including a plurality of legs for holding said end walls above a lower surface of a pool in which said rack is submerged.
